(19) United States
(12) Patent Application Publication
(10) Pub. No.: US 2023/0121024 A1
(43) Pub. Date: Apr. 20, 2023

(54) MULTIFUNCTION SECURITY ELEMENT

(71) Applicant: FASE S.R.L., Milan (IT)

(72) Inventors: Orazio AUDINO, Bollate (IT); Francesco BERARDI, Bollate (IT); Geremino CAMMISA, Vanzago (IT); Luca CIMATTI, Luisago (IT)

(21) Appl. No.: 17/596,406

(22) PCT Filed: Jun. 30, 2020
(86) PCT No.: PCT/EP2020/068383

§ 371 Date: Dec. 9, 2021

(51) Int. Cl. B42D 25/328; B42D 25/351; B42D 25/373; B42D 25/387; B42D 25/445; B42D 25/364; B42D 25/369; B42D 25/47

(52) U.S. Cl. CPC B42D 25/328; B42D 25/351; B42D 25/373; B42D 25/387; B42D 25/445; B42D 25/364; B42D 25/369; B42D 25/47

(57) ABSTRACT

A security element includes a first transparent film, on which a holographic layer is formed having a holographic surface structure, a reflective layer arranged in contact with the holographic layer having a pattern of non-transparent regions and transparent regions, a color changing layer, and a photoactive layer having dark regions and transparent regions. In first regions, parts of the non-transparent regions of the reflective layer are not overlapped by the dark regions of the photoactive layer. In second regions, the color changing layer is backed by the dark regions of the photoactive layer. In third regions, the transparent regions of the photoactive layer are at least partly in register with the transparent regions of the reflective layer so that the third regions are continuous when passing from patterns outside the non-transparent regions of the reflective layer to patterns outside the dark regions of the photoactive layer.

### BACKGROUND OF THE INVENTION

### Field of the Invention

The invention relates to a security element which can have the form of strips or patches and which is used in connection with banknotes, official and unofficial documents like passports, ID-cards, bank and credit cards, checks, paper, coupons vouchers, tickets, packages or the like. Provision of the mentioned documents with the security element improves the protection against forgery.

### Description of the Related Art

Security elements typically have different characteristics that may be recognized by visual inspection, such as color changes, holographic pictures, characters, patterns, which may particularly develop a different appearance according to the angle and direction of the observation with the naked eye. This allows a quick and reliable detection of forgery without requiring any equipment. Therefore, observable effects shall be made prominent in occurrence, so that a missing optical effect is quickly recognized to quickly identify a forgery. Of course, the security element shall be very difficult or impossible to copy in order to reduce the potential of forgery.

In addition, security elements may contain characteristics recognizable by machines. Such characteristics are preferably invisibly provided in the security element, so that forgery of these characteristics is impeded. Magnetic codes based on different coercivity, patterns or the like are typical examples for such characteristics, however optical characteristics with invisible rays (e.g. UV- or IR light) may be used as such characteristics.

EP 1 467 873 B1 describes a method for manufacturing a substrate which is to be used as a security element. The manufacturing process includes the formation of a metallic layer on a first side of a transparent polymeric film. A resist layer made from a darkly colored resist is then applied on the metallic layer, the resist layer forming areas on the metallic layer that are covered by the resists and areas on the metallic layer which are not covered by the resist and the metallic layer is exposed. Then, the metal is removed for the areas that are not covered by the resist by a demetallization process, so as to form demetallized regions. Then a further layer of a polymeric liquid crystal material is applied on the resist layer and the demetallized regions. The layer of polymeric liquid crystal material is optically active and develops a color change or color shift depending on the angle of observation.

With respect to the above security element, because the metallic layer is covered with the dark colored resist layer in the metallic areas, the color shift effect of the polymeric liquid crystal material is clearly visible in reflected light. On the other hand, the demetallized regions are clearly distinguishable from the metallic areas in transmitted light. In the known manufacturing method, the various layers are laminated one upon the other on one side of the transparent film.

In another related prior art document EP 3314335 B1, a method for manufacturing a security element is described, according to which a holographic surface structure is formed on first and second transparent layers, which are then metallized to form first and second metal layers. Consequently, a pattern of a coating is formed on the second metal layer, said pattern comprising regions covered by the coating and regions uncovered by the coating, and the metal in regions of the second metal layer which are uncovered by the coating is removed by a process of de-metallization. The demetallized regions of the second layer are exposed to light or radiation so as to transfer the radiation-sensitive polymer in the de-metallized regions into a soluble state. Finally, the soluble radiation-sensitive polymer is removed, and the metal in regions of the first metal layer, which are not covered by the second layer, are removed by a process of de-metallization.

With respect to a security element manufactured by the above method, visual inspection in transmitted light will disclose overlapping portions of transparent regions in the first and second metal layers as a pattern, while visual inspection of the security element in reflected light will show a holographic effect on each of the two sides of the security element, i.e. front surface/rear surface.

### SUMMARY OF THE INVENTION

In view of the above, it is the object of the invention to provide a security element which has an improved security by accurately combining multiple effects so as to display a clear and sharp picture in visual inspection, and a method for making the same.

With respect to the security element, the object is solved by a security element having the features of claim 1, and with respect to the method, the object is solved by a method according to claim 14.

According to the invention, a security element comprises a first transparent film, on which a holographic layer is formed having a holographic surface structure, a reflective layer arranged in contact with the holographic layer having a pattern of non-transparent regions and transparent regions, a color changing layer, and a photoactive layer having dark regions and transparent regions. In first regions, parts of the non-transparent regions of the reflective layer are not overlapped by the dark regions of the photoactive layer. In second regions, the color changing layer is backed by the dark regions of the photoactive layer. In third regions, the transparent regions of the photoactive layer are at least partly in register with the transparent regions of the reflective layer so that the third regions are continuous when passing from patterns outside the non-transparent regions of the reflective layer to patterns outside the dark regions of the photoactive layer.

With this arrangement, when viewed in reflected light, a holographic effect is visible in the first regions and simultaneously a color change effect is clearly visible in the second regions. Furthermore, when viewed in transmitted light, a transparency effect is visible in the third regions. Accordingly, a multifunction security element is provided, in which security is improved by combining multiple effects in visual inspection.

The invention provides a security element having at least three security features which are visually recognizable with the naked eye. One of these security features is a pattern which is clearly and sharply recognizable in transmission, i.e. light transmitted through the security element. In brief, a person holding the security into the light and observing the side of the security element which is turned away from the light source will see a pattern which is made up from the transparent regions which appear lit in a dark surface. This effect will be obtained independent from the side which is exposed to the light source. One reason for this effect is seen in that the patterns of transparent and non-transparent or dark regions are formed in perfect register on both sides of the transparent film.

Furthermore, when the security element is observed in reflected light (i.e. the observer and the light source are on the same side of the security element) the side carrying the color changing layer will show a slight color change effect in all regions which are covered by the color changing layer. If the transmission of reflected light through the color changing layer is suppressed, e.g. by an underlying photoactive layer, the color changing layer will appear more clearly as a continuous layer changing its color depending on the angle of observation. Simultaneously, a holographic effect will be exhibited in regions which are not covered by the photoactive layer and are also non-transparent in the reflective layer.

Preferably, the pattern of the reflective layer is composed of metallic regions and metal-free regions.

When the non-transparent regions of the reflective layer are made from metal, the visibility of the holographic effect is improved. Accordingly, the observation of the security element in reflected light reveals a shiny or bright holographic effect. Furthermore, metallic materials are advantageous for masking the photoactive layer so as to define exposed and non-exposed regions when light or radiation are applied to one side of the security element.

Preferably, the photoactive layer is made of a radiation-sensitive coating responsive to light or radiation.

In this case, the pattern consisting of transparent and non-transparent regions is formed in the reflective layer, and the photoactive layer is made of a coating responsive to light or radiation. When the film is irradiated with light or radiation from the side of the reflective layer, the reflective layer acts as a mask having the pattern. Therefore, a simple treatment of the whole reflective layer from one side of the security element results in accurately selected local treatment of the photoactive layer made of a coating responsive to light or radiation, which results in the same pattern of transparent and dark regions in the photoactive layer.

Thereby, the transparent regions of the reflective layer and the transparent regions of the photoactive layer can be provided in accurate register.

Preferably, the radiation-sensitive coating is a photo-resist, a varnish or an ink that dissolves, becomes soluble or breaks down when exposed to light or radiation.

In this case, when the light or radiation reaches the regions on the photoactive layer side of the security element which are not masked, e.g. reaches the regions which correspond to the transparent regions on the reflective layer side of the security element, the coating in said regions dissolves or becomes chemically unstable, e.g. soluble in particular liquids. Therefore, after exposure, the irradiated portions of the photoactive layer may be washed away using these liquids, while the portions which were not exposed to radiation remain stably on the photoactive layer side of the security element.

Preferably, the color changing layer comprises at least one of a liquid crystal polymer, a thin film and a pigment ink and is formed continuously or with patterns on a second transparent film.

Any of these types of materials provide a color change effect, which means that the color of the portion of the security element which is observed, changes its color depending on the angle of observation of that portion of the security element. Typically, the span of the change in wavelength of the reflected light depending on the angle of observation—which exhibits the color change effect—is different for the individual materials, but is almost a constant span for the individual material. That means, suitably selecting the span of wavelength change within a spectrum of light can generate a desired color change from one predetermined color to another. Liquid crystal polymer is known for a strong color change effect and easy application, so that this material may be preferred. By forming the color changing layer on a second transparent film, the manufacturing process is simplified.

Preferably, the first transparent film and/or the second transparent film comprises PET.

PET (Polyethylene terephthalate) is a robust and durable material that enables a simple and cost-efficient manufacturing process.

Preferably, the security element further comprises a magnetic material in the dark regions of the pattern of the photoactive layer or in a separate magnetic layer, forming a machine-readable information carrier in correspondence to the entire dark regions of the photoactive layer or parts thereof.

The provision of magnetic materials to form a coding which is machine readable is an additional security feature which may be combined further to the three security features already combined in the multifunction security element. Since the magnetic material is typically non-transparent or dark, it is advantageously arranged in non-transparent or dark regions of the security element, which regions may be the first and second regions described above. This has the advantage that the magnetic coding will not interfere with the appearance of the security element obtained in transmitted light. Providing the magnetic coding in the second regions, more specifically in the dark regions of the photoactive layer, further avoids interference with the holographic effect. Accordingly, the magnetic coding may be hidden in connection with the dark regions, so that the coding may not be recognized when visually inspecting the security element.

Preferably, a clear coating is provided, the clear coating comprising materials having at least one of a fluorescent, a luminescent, and a phosphorescent effect.

In this way, a further security feature may be added to the multifunction security element. When the optically active (fluorescent, luminescent, phosphorescent) coating is provided in the transparent regions of the photoactive layer, then an additional optical effect may be observed in the third region when suitable radiation (e.g. UV light) is applied. For example, when using a fluorescent coating, signs or the like in the pattern may appears illuminated when the security element is observed in transmitted UV light.

Preferably, the reflective layer is provided with a resist layer covering at least the pattern, and the resist layer is transparent or colored.

Thereby, it is possible to form the pattern in the reflective layer by an etching process that includes covering the intended non-transparent regions with the resist layer and removing the intended transparent regions which are uncovered by the coating. Furthermore, durability of the reflective layer is improved. In addition, when the resist layer is colored, an additional optical effect is provided in the multifunction security element.

Preferably, an adhesive layer is arranged between the color changing layer and the photoactive layer.

In this way, application of the color changing layer to the photoactive layer is simplified. For example, the photoactive layer may be formed or fixed to the first transparent film, thereby forming a structure comprising the photoactive layer, the transparent film, the holographic layer and the reflective layer. This structure can be easily handled and different types of color changing layers can be applied as a separate step in manufacturing. In addition, the color change effect is not subjected to the treatment comprising light or radiation, which reduces the risk of damaging the color changing layer during manufacturing.

Preferably, a protective layer is provided so that intrusion of liquids or debris is avoided and resistance to mechanical wear at the edges of the gaps is inhibited. This ensures a clear appearance of the security features of the security element over long time, thereby improving durability.

Preferably, an adhesive or a thermo-adhesive is provided on external surfaces of the security element.

In this way, application of the security element to a carrier (banknote or the like) is possible by the application of heat and pressure.

Preferably, when viewed in reflected light under a perpendicular angle, a first holographic image is viewable in the first regions and a first color in the second regions, and when viewed in reflected light under an acute angle, a second holographic image is viewable in the first regions and a second color in the second regions.

As described above, the color changing layer exhibits an angle-dependent color change effect. Holographic images are also dependent on the angle of the incident light. Advantageously, both layers exhibit a respective first effect at a perpendicular angle, and a respective second effect at an acute angle. Thereby, security is further improved.

The method for manufacturing a security element according to the invention comprises steps of: forming a holographic layer on a first transparent film; forming a holographic surface structure on the holographic layer; metallization of the holographic layer so as to form a reflective layer with a pattern comprising non transparent regions and transparent regions; forming a photoactive layer from a radiation-sensitive polymer, the photoactive layer partly overlapping the holographic layer with a pattern; exposing at least the transparent regions of the reflective layer to a treatment comprising light or radiation, wherein the reflective layer serves as a masking layer for exposing only partial regions of the photoactive layer to the treatment, and the exposed regions of the photoactive layer respond to the treatment by dissolving, becoming soluble or breaking down; removing the exposed regions of the photoactive layer; forming a color changing layer on a second transparent film; and laminating the second transparent film and the color changing layer with an adhesive to the structure formed on the transparent film.

With the method described, the transparent and dark regions of the photoactive layer and the transparent and non-transparent regions of the reflective layer are obtained in accurate register. This allows a clear and sharp definition of a security feature in the form of a pattern observable in transmitted light, and it allows the application of at least a color change effect and a holographic effect in reflected light.

Preferably, the exposed regions of the photoactive layer are destabilized by UV light and the destabilized regions are dissolved and removed in a chemical bath.

Thereby, the pattern of transparent and dark regions of the photoactive layer is formed in register with the pattern of the reflective layer by a simple process.

Preferably, a protective layer is formed so that intrusion of liquids or debris is avoided and resistance to mechanical wear at the edges of the gaps is inhibited. This ensures a clear appearance of the security features of the security element over long time, thereby improving durability.

Preferably, a glue layer comprising an adhesive or a thermo-adhesive is formed on external areas so that the application of the security element to a carrier (banknote or the like) is possible by the application of heat and pressure.

Preferably, a clear coating is formed, the clear coating comprising materials having at least one of a fluorescent, a luminescent, and a phosphorescent effect.

Thereby, an additional security feature can be provided as described above.

Preferably, a magnetic material is formed in the dark regions of the pattern of the photoactive layer or in a separate magnetic layer so as to form a machine-readable information carrier in correspondence to the entire dark regions of the photoactive layer or parts thereof.

Thereby, an additional security feature can be provided as described above.

Preferably, the pattern in the reflective layer is obtained by a selective metallization or an etching process, which includes covering the non-transparent regions by a coating being a resist, and removing of the metal in regions of the reflective layer which are uncovered by the coating by a process of de-metallization.

Thereby, the pattern of transparent and non-transparent regions of the reflective layer is formed by a simple process.

### BRIEF DESCRIPTION OF THE DRAWINGS

In the following, the invention will be explained in detail by reference being made to a preferred embodiment as is shown in the drawings, in which:

FIG. 1 is a top view of a security element according to a preferred embodiment of the invention,

FIG. 2 is a schematic cross-sectional view taken along the line II-II in FIG. 1,

FIG. 3 is an overview showing a relationship between visible effects and regions of the security element in the embodiment, and

FIG. 4 is a schematic cross-sectional view of a security element according to a modification of the embodiment, corresponding to the line II-II in FIG. 1.

FIG. 5 is a schematic cross-sectional view of a security element according to another modification of the embodiment, corresponding to the line III-III in FIG. 1.

### DETAILED DESCRIPTION OF THE PREFERRED EMBODIMENT

It is noted that the size relations of the individual elements are drawn arbitrarily for explanation purposes and do not correspond to the actual size relations or proportions. In the description of the drawings, the terms upper and lower, above, underneath etc. are used in relation to the drawings as shown. These terms are not limiting, because an opposite orientation of the security element during manufacturing and use is possible and likely, so that these terms will have to be adapted accordingly. Also, term like first, second and third or the like are derived from the order of manufacturing, and are not limiting the scope of the claims, when counting the order of layers in the final product.

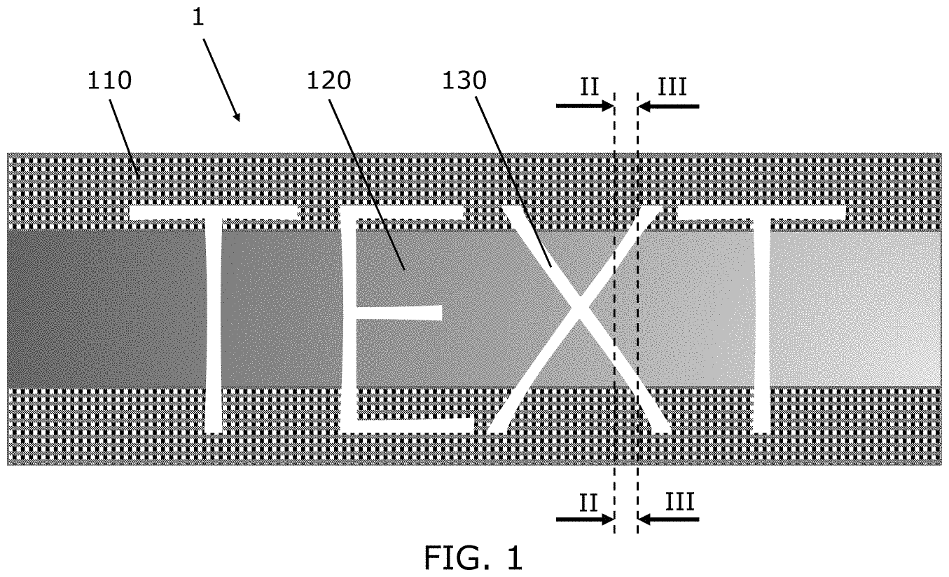

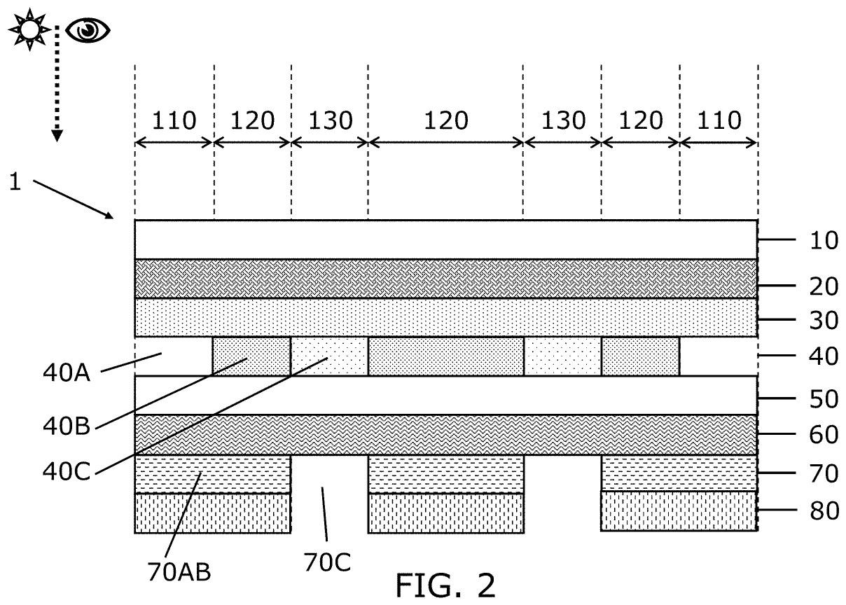

FIG. 1 is a top view of a segment of a security element 1 according to a preferred embodiment of the invention, and FIG. 2 is a schematic cross-sectional view of the security element 1 taken along the line II-II in FIG. 1.

As shown in FIG. 2, the security element 1 comprises a transparent film 50 (first transparent film 50), which serves as a carrier on which all other layers are formed and treated. The transparent film 50 is preferably made of a PET (polyethylene terephthalate) film which has a high transparency and which is stable in shape and is sturdy.

A holographic layer 60 is formed on one side of the transparent film 50. The holographic layer 60 includes a holographic surface structure. In the embodiment, the holographic layer 60 is formed as a surface structure applied to the lower surface of the transparent film 50 in FIG. 2. In other words, the holographic layer 60 is a surface structure embossed into the material of the transparent film 50; however, the holographic layer 60 may be a separate layer. The surface structure is suited to form a holographic picture or effect. In the drawing of FIG. 2, the wavelike filling effect is used to express an irregular or rough surface structure which forms the holographic layer 60.

A reflective layer 70 is arranged in contact with the holographic layer 60 and has a pattern of non-transparent regions 70AB and transparent regions 70C. The transparent regions 70C (which may be gaps) in the pattern form, together with the non-transparent regions 70AB, one or more pictures, symbols, letters, text, numbers or the like including combinations thereof, as indicated by “TEXT” in FIG. 1. The reflective layer 70 is made of metal, but may alternatively be made of other non-transparent, suitably applicable materials such as ink, varnish or pastes. In the embodiment, a metal layer is applied first on the holographic layer 60 and then a demetallization process is used to make gaps in the metal layer so as to form the transparent regions 70C. Alternatively, the non-transparent regions 70AB may be directly formed from metal or another material, leaving the transparent regions 70C free from material during the manufacturing of this layer.

A resist layer 80 is provided adjacent to the reflective layer 70 and covers the pattern of non-transparent regions 70AB. The resist layer 80 is optional and serves to enable manufacturing of the transparent regions by an etching process, i.e. by covering the intended non-transparent regions 70AB with the resist layer 80 and removing the metal in the intended transparent regions 70C of the reflective layer 70 which are uncovered by the resist layer 80 by a process of de-metallization. Furthermore, the resist layer 80 improves durability of the reflective layer 70. In addition, the resist layer 80 may be colored so as to provide an optical effect. The resist layer 80 may be omitted, for example when the pattern in the reflective layer 70 is obtained by selective metallization, or may be removed after obtaining the pattern by etching.

A photoactive layer 40 is formed on the other side of the transparent film 50 opposite of the side on which the reflective layer 70 is provided. The photoactive layer 40 is a layer that absorbs at least parts of incident light and light reflected by the reflective layer 70. Preferably, the photoactive layer 40 is black or blue. The photoactive layer 40 has dark regions 40B and transparent regions 40C. In addition, regions exist in which the photoactive layer 40 is not present (does not overlap the reflective layer 70); these regions will be referred to as excluded regions 40A.

The photoactive layer 40 may be made of a radiation-sensitive coating responsive to light or radiation. The radiation-sensitive coating may be a photo-resist, a varnish or an ink that dissolves, becomes soluble or breaks down when exposed to light or radiation. In the embodiment, the photoactive layer 40 is made of a photoactive polymer comprising dark pigments (indicated by a densely dotted pattern in FIG. 2), which is destabilized by UV light (indicated by a less densely dotted pattern in FIG. 2). The resist of the photoactive layer 40 is irradiated with UV light while using the reflective layer 70 as a masking layer, such that only the transparent regions 70C of the reflective layer 70 allow the UV light to pass, thereby destabilizing only the regions 40C of the photoactive resist of the photoactive layer 40. The destabilized photoactive resist can be then washed away in a chemical bath so as to form transparent regions 40C in the photoactive layer 40. Due to using the reflective layer 70 as a masking layer, the transparent regions 40C of the photoactive layer 40 are in perfect register with the transparent regions 70C of the reflective layer 70.

A color changing layer 20 is provided on the other side of the transparent film 50 on the side of the photoactive layer 40. In the embodiment, the color changing layer 20 is formed continuously on a second transparent film 10, which has the same function as the first transparent film 50, and the color changing layer 20 is attached to the photoactive layer 40 by an adhesive layer 30. Alternatively, the color changing layer 20 may be provided with patterns and may be formed directly on the photoactive layer 40. Furthermore, any one of the second transparent film 10 and the adhesive layer 30 may be omitted. Preferably, the color changing layer 20 comprises at least one of a liquid crystal polymer, a thin film and a pigment ink.

The function of the security element shown in FIGS. 1 to 3 is as follows:

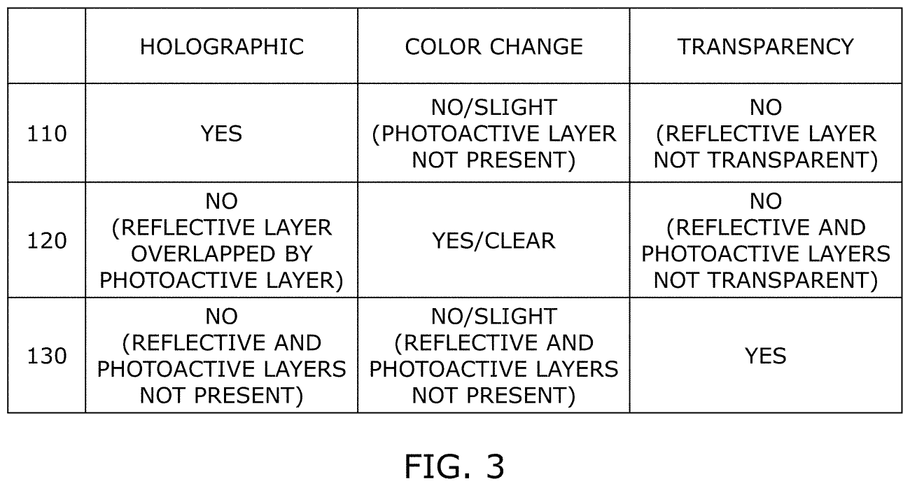

In accordance with the laminated layers, three distinct regions 110, 120, 130 can be recognized in the security element when viewed from above as shown in FIG. 1. Each region is defined by an overlap or non-overlap (presence or non-presence) of layers, which are best visible in FIG. 2. FIG. 3 is an overview showing which effect is visible in which region of the security element 1.

In first regions 110, the reflective layer 70 is not overlapped by the photoactive layer 40 and specifically the dark regions 40B of the photoactive layer 40. In other words, in the first regions 110, the reflective layer 70 is overlapped by the excluded regions 40A, in which the photoactive layer 40 is not present. At the same time, the holographic layer 60 is backed by the reflective layer 70. Accordingly, a holographic effect is clearly visible in the first regions 110 when viewed in reflected light (from above in FIG. 2, as indicated by a dashed arrow). The color changing layer 20 is also present in the first regions 110, but light reflected by the reflective layer 70 and transmitted through the excluded regions 40A results in that only a slight color change effect or no color change effect at all can be perceived by the viewer.

In second regions 120, the reflective layer 70 is overlapped by the color changing layer 20, which in turn is backed by the dark regions 40B of the photoactive layer 40 when viewed in reflected light (from above in FIG. 2). Consequently, the color changing layer 20 is backed by the dark regions 40B so as to greatly increase visibility of the color change effect. Accordingly, the color change effect is clearly visible in the second regions 120. At the same time, the holographic layer 60 is also overlapped by the dark regions 40B of the photoactive layer 40. Accordingly, the holographic effect is not visible in the second regions 120.

In third regions 130, the transparent regions 40C of the photoactive layer 40 and the transparent regions 70C of the reflective layer 70 overlap. Specifically, the transparent regions 40C, 70C forming the third regions 130 are in register, i.e. are continuous when passing from patterns outside the non-transparent regions 70AB of the reflective layer 70 to patterns outside the dark regions 40B of the photoactive layer 40. Consequently, the holographic layer 60 is not backed by a reflective layer and the color changing layer 20 is not backed by a photoactive layer in the third regions 130. Accordingly, when viewed in reflected light (from above in FIG. 2), the holographic effect is not visible and the color change effect is also not visible or only slightly visible in the third regions 130. This may appear to the viewer as a pattern that does not include the holographic or color change effects when viewed in reflected light. However, when viewed in transmitted light (from below in FIG. 2), the security element 1 appears transparent in the third regions 130. Consequently, the pattern comprising one or more pictures, symbols, letters, text, numbers or the like including combinations thereof is clearly seen as transparent in transmitted light.

Accordingly, the embodiment provides a security element with at least three optical anti-forgery effects.

The following modifications of the described embodiments shall be embraced by this description:

In the security element 1 according to the preferred embodiment shown in FIGS. 1 and 2, the photoactive layer 40 is formed on a side of the transparent film 50 opposite of a side on which the reflective layer 70 is provided, and all layers of the security element are laminated in the order described above. However, this is not necessary for the effects of the invention.

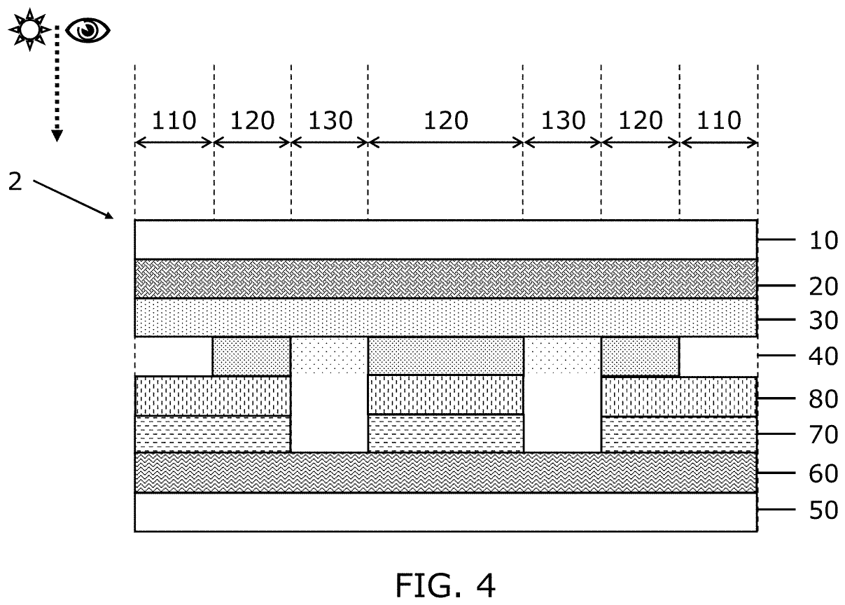

FIG. 4 shows a security element 2 according to a modification of the preferred embodiment. In the security element 2, all layers 40 to 80 are laminated on one side of the first transparent film 50 and the color changing layer 20 is adhered by the adhesive layer 30 as a final step. In addition, the reflective layer 70 is provided so as to cover the holographic layer 60 when viewed from above. As for security element 1, the reflective layer 70 is embossed on the holographic layer 60 and assumes its surface structure. Thereby, the holographic effect can still be exhibited. Accordingly, the security element 2 shown in FIG. 4 results in the same first regions 110, second regions 120 and third regions 130 along with their respective optical effects and corresponding security features.

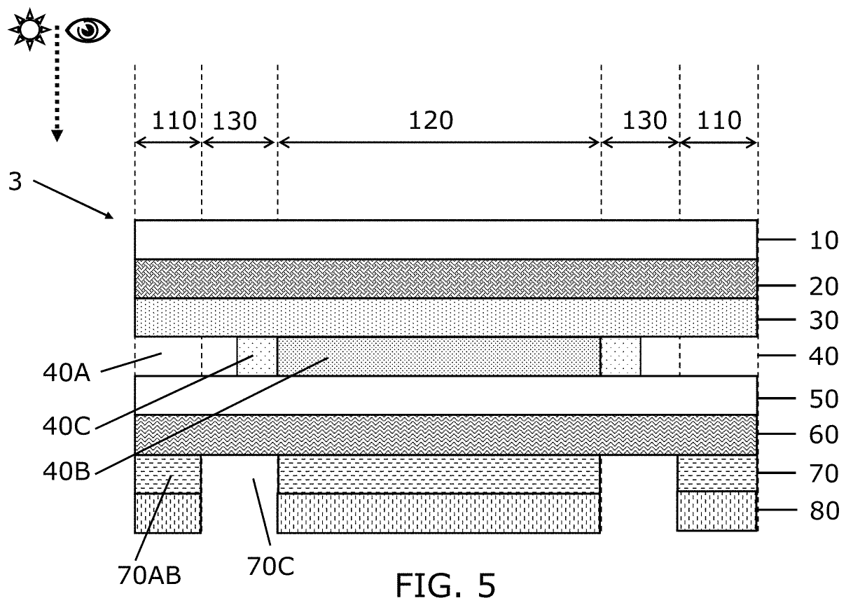

FIG. 5 shows a security element 3 according to another modification of the preferred embodiment representing a schematic cross-sectional view taken along the line III-III. In the security element 1 according to the preferred embodiment shown in FIGS. 1 and 2, in third regions 130, the transparent regions 40C of the photoactive layer 40 and the transparent regions 70C of the reflective layer 70 overlap (are in register). By contrast, in the security element 3 according to this modification example, the transparent regions 70C are overlapped by parts of the excluded regions 40A in addition to the transparent regions 40C. In other words, the transparent region 40C and a part of the excluded regions 40A are in register with the transparent regions 70C so as to form the third regions 130. The effects described above with respect to the security elements 1, 2 are also exhibited by the security element 3 so long as the third regions 130 are continuous when passing from patterns outside the non-transparent regions 70AB of the reflective layer 70 to patterns outside the dark regions 40B of the photoactive layer 40.

The order of laminating during manufacturing and in the final product is not necessarily the order described above with respect to the preferred embodiment, but may be any other order that results in the first, second and third regions 110, 120 and 130. In such a case, all security features described above with respect to the preferred embodiment are still exhibited.

As described above, the color changing layer exhibits an angle-dependent color change effect. Holographic images are also dependent on the angle of the incident light. Advantageously, both layers exhibit a respective first effect at a perpendicular angle, and a respective second effect at an acute angle. In this case, when viewed in reflected light under a perpendicular angle, a first holographic image is viewable in the first regions and a first color in the second regions, and when viewed in reflected light under an acute angle, a second holographic image is viewable in the first regions and a second color in the second regions. Thereby, security is further improved.

The photoactive layer may further comprise a magnetic pattern of magnetic materials which is formed from blocks of a first magnetic material, gaps, and blocks of a different magnetic material. The gaps and materials of the magnetic pattern form a magnetic coding as a security feature that can be detected by suitable equipment. In order to prevent the magnetic pattern or coding from being invisible, the blocks of the magnetic materials may be arranged in the dark regions 40B of the photoactive layer 40 so that they cannot be observed in transmitted light. Additionally, the blocks of the magnetic coding may be made from a dark material similar to that of the photoactive layer 40. Alternatively, the magnetic coding may be hidden in a separate magnetic layer that corresponds to the entire dark regions 40B of the photoactive layer 40 or to parts thereof. The optical performance of such a security element can nevertheless be the same as that of the preferred embodiment.

Further to the structure shown in FIGS. 2 and 4, a clear coating may be formed, the clear coating comprising materials having at least one of a fluorescent, a luminescent, and a phosphorescent effect. In this way, a further security feature can be added to the multifunction security element without interfering with the holographic effect. When the optically active (fluorescent, luminescent, phosphorescent) clear coating is provided in the transparent regions 40C of the photoactive layer 40, then an additional optical effect may be observed in the third region 130 when suitable radiation (e.g. UV light) is applied. For example, when using a fluorescent coating, signs or the like in the pattern may appears illuminated when the security element is observed in transmitted UV light.

Further to the structure shown in FIGS. 2 and 4, a protective layer may be applied to cover the exposed surfaces of the layers and to fill gaps formed in the layers, particularly the gaps formed by the transparent regions of the patterns. Such a protective layer improves durability and damage resistance in daily use of the security element. This protective layer typically is a clear layer which shows no change of the optical effects of the security elements.

Further to the structure shown in FIGS. 2 and 4, a glue layer comprising an adhesive or a thermo-adhesive may be applied to the protective layer or external surfaces of the security element in order to permit application of the security element to a carrier (banknote or the like) by the application of heat and pressure.

The invention may be further modified in various embodiments within the skills of the person skilled in art and within the scope of the claims.

### LIST OF REFERENCE SIGNS

| | |
|---|---|
| 1, 2, 3 | security element |
| 10 | second transparent film |
| 20 | color changing layer |
| 30 | adhesive layer |
| 40 | photoactive layer |
| → 40A | excluded regions |
| → 40B | dark regions |
| → 40C | transparent regions |
| 50 | first transparent film |
| 60 | holographic layer |
| 70 | reflective layer |
| → 70AB | dark regions |
| → 70C | transparent regions |
| 80 | resist layer |
| 110 | first regions |
| 120 | second regions |
| 130 | third regions |

1. A security element comprising:
a first transparent film, on which a holographic layer is formed having a holographic surface structure;
a reflective layer arranged in contact with the holographic layer having a pattern of non-transparent regions and transparent regions;
a color changing layer; and
a photoactive layer having dark regions and transparent regions, wherein
when viewed in reflected light,
a holographic effect is visible in first regions, in which parts of the non-transparent regions of the reflective layer are not overlapped by the dark regions of the photoactive layer, and
a color change effect is clearly visible in second regions, in which the color changing layer is backed by the dark regions of the photoactive layer; and
when viewed in transmitted light, a transparency effect is visible in third regions, in which the transparent regions of the photoactive layer are at least partly in register with the transparent regions of the reflective layer so that the third regions are continuous when passing from patterns outside the non-transparent regions of the reflective layer to patterns outside the dark regions of the photoactive layer.

2. The security element according to claim 1, wherein the pattern of the reflective layer is composed of metallic regions and metal-free regions.

3. The security element according to claim 1, wherein the photoactive layer is made of a radiation-sensitive coating responsive to light or radiation.

4. The security element according to claim 3, wherein the radiation-sensitive coating is a photo-resist, a varnish or an ink that dissolves, becomes soluble or breaks down when exposed to light or radiation.

5. The security element according to claim 1, wherein the color changing layer comprises at least one of a liquid crystal polymer, a thin film and a pigment ink and is formed continuously or with patterns on a second transparent

6. The security element according to claim 1, wherein the first transparent film and/or the second transparent film comprises PET.

7. The security element according to claim 1, further comprising a magnetic material in the dark regions of the pattern of the photoactive layer or in a separate magnetic layer, forming a machine-readable information carrier in correspondence to the entire dark regions of the photoactive layer or parts thereof.

8. The security element according to claim 1, wherein a clear coating is provided, the clear coating comprising materials having at least one of a fluorescent, a luminescent, and a phosphorescent effect.

9. The security element according to claim 1, wherein
the reflective layer is provided with a resist layer covering at least the pattern, and
the resist layer is transparent or colored.

10. The security element according to claim 1, wherein an adhesive layer is arranged between the color changing layer and the photoactive layer.

11. The security element according to claim 1, wherein a protective layer is provided.

12. The security element according to claim 1, wherein a glue layer comprising an adhesive or a thermo-adhesive is provided on external surfaces of the security element.

13. The security element according to claim 1, wherein
when viewed in reflected light under a perpendicular angle a first holographic image is viewable in the first regions and a first color in the second regions and
when viewed in reflected light under an acute angle a second holographic image is viewable in the first regions and a second color in the second regions.

14. A method for manufacturing a security element, comprising:
forming a holographic layer on a first transparent film;
forming a holographic surface structure on the holographic layer;
metallization of the holographic layer so as to form a reflective layer with a pattern comprising non transparent regions and transparent regions;
forming a photoactive layer from a radiation-sensitive polymer, the photoactive layer partly overlapping the holographic layer with a pattern;
exposing at least the transparent regions of the reflective layer to a treatment comprising light or radiation, wherein
the reflective layer serves as a masking layer for exposing only partial regions of the photoactive layer to the treatment, and
the exposed regions of the photoactive layer respond to the treatment by dissolving, becoming soluble or breaking down;
removing the exposed regions of the photoactive layer;
forming a color changing layer on a second transparent film; and
laminating the second transparent film and the color changing layer with an adhesive to the structure formed on the transparent film.

15. The method according to claim 14, wherein the exposed regions of the photoactive layer are destabilized by UV light and the destabilized regions are dissolved and removed in a chemical bath.

16. The method according to claim 14, wherein a glue layer comprising an adhesive or a thermo-adhesive layer is formed on external areas of the security element.

17. The method according to claim 14, wherein a protective layer is provided with the glue layer.

18. The method according to claim 14, wherein a clear coating is formed, the clear coating comprising materials having at least one of a fluorescent, a luminescent, and a phosphorescent effect.

19. The method according to claim 14, wherein a magnetic material is formed in the dark regions of the pattern of the photoactive layer or in a separate magnetic layer so as to form a machine-readable information carrier in correspondence to the entire dark regions of the photoactive layer or parts thereof.

20. The method according to claim 14, wherein the pattern in the reflective layer is obtained by
a selective metallization, or
an etching process including
covering the reflective regions by a coating being a resist, and
removing of the metal in regions of the reflective layer which are uncovered by the coating by a process of de-metallization.
